(19) United States
(12) Patent Application Publication
(10) Pub. No.: US 2021/0233151 A1
(43) Pub. Date: Jul. 29, 2021

(54) ENHANCED COMPLEMENTARY RECOMMENDATION

(71) Applicant: Walmart Apollo, LLC, Bentonville, AR (US)

(72) Inventors: Habibur RAHMAN, San Jose, CA (US); Sriram Guna Sekhar KOLLIPARA, Sunnyvale, CA (US); Zeinab TAGHAVI NASR ABADI, Oakland, CA (US); Omkar DESHPANDE, Saratoga, CA (US)

(21) Appl. No.: 16/776,247

(22) Filed: Jan. 29, 2020

(51) Int. Cl. G06Q 30/06; G06F 16/9535; G06F 16/2457; G06N 5/04

(52) U.S. Cl. CPC G06Q 30/0631; G06F 16/9535; G06F 16/24578; G06N 20/00; G06Q 30/0629; G06N 5/04; G06Q 30/0633

(57) ABSTRACT

An approach is disclosed for providing enhanced complementary recommendations. The approach receives an anchor item. The approach determines one or more items similar to the anchor item, based on at least one of co-view data and content data of the anchor item. The approach determines one or more items that complement the one or more similar items, based on co-purchase data of the one or more similar items. The approach generates recommended complementary item data for the anchor item. The approach generates the recommended complementary item data based on the co-purchase data and at least one of the co-view data and the content data.

### TECHNICAL FIELD

The disclosure relates generally to providing complementary recommendations, and more particularly, for providing complementary recommendations using transfer learning.

### BACKGROUND

When a customer purchases an item on an e-commerce website, the customer may select and add the item to the customer's cart. The e-commerce website may display the item (i.e., an anchor item) on, for example, an add-to-cart page, and recommend (i.e., cross-sell) items that complement the anchor item. Typically, complementary items may include items that other customers purchased along with purchasing the anchor item.

Conventional cross-selling models utilize co-purchase data for the anchor item to determine which complementary items to display with the anchor item. The co-purchase data may include a history of complementary items that other customers purchased when purchasing the anchor item. However, for the cases in which the anchor item has little to no co-purchase data (i.e., a cold start item), the conventional cross-selling models may not have enough or any co-purchase data related to the cold start anchor item to recommend a complementary item.

Moreover, by utilizing only co-purchase data to recommend complementary items, conventional cross-selling models may not provide the customer with the broadest possible coverage of complementary items. For example, an e-commerce website may offer about eighty million items for sale. However, customers may purchase the same complementary items for an anchor item, thereby creating co-purchase data for these complementary items and none for other complementary items. Thus, out of the eighty million items, the cross-selling models may recommend only a small portion of the eighty million items for sale. In another example, as cross-selling models typically rely on co-purchase data to recommend complementary items, these models may generate complementary items based on data that corresponds to items that customers purchased, and may fail to recommend complementary items that customers viewed. As such, conventional cross-selling models may only utilize about fifty percent of the data traffic generated by customers.

### SUMMARY

The summary of the disclosure is given to aid understanding of providing enhanced complementary recommendations using transfer learning and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, devices, and their methods of operation to achieve different effects. Certain aspects of the present disclosure provide a system, method, and non-transitory computer readable medium for providing enhanced complementary recommendations.

The embodiments described herein are directed to a means of providing enhanced complementary recommendations using transfer learning. To provide enhanced complementary recommendations for cold start items, the embodiments may generate the complementary recommendation data by leveraging data from similar items, such as co-view data or content data, and their recommended complementary items, such as co-purchase data.

In one or more cases, the disclosed technology relates to a system that includes a computing device. In one or more cases, the computing device is configured to receive an anchor item. In one or more cases, the computing device is configured to determine one or more items similar to the anchor item, based on at least one of co-view data and content data of the anchor item. In one or more cases, the computing device is configured to determine one or more items that complement the one or more similar items, based on co-purchase data of the one or more similar items. In one or more cases, the computing device is configured to generate recommended complementary item data for the anchor item. In one or more cases, the recommended complementary item data is generated based on the co-purchase data and at least one of the co-view data and the content data.

In one or more other cases, the disclosed technology relates to a method. In one or more cases, the method comprises receiving an anchor item. In one or more cases, the method comprises determining one or more items similar to the anchor item, based on at least one of co-view data and content data of the anchor item. In one or more cases, the method comprises determining one or more items that complement the one or more similar items, based on co-purchase data of the one or more similar items. In one or more cases, the method comprises generating recommended complementary item data for the anchor item. In one or more cases, the recommended complementary item data is generated based on the co-purchase data and at least one of the co-view data and the content data.

In yet one or more other cases, the disclosed technology relates to a computer program product. In one or more cases, the computer program product comprises a non-transitory computer readable medium having program instructions stored thereon. In one or more cases, the program instructions may be executable by one or more processors. In one or more cases, the program instructions comprise determining one or more items similar to the anchor item, based on at least one of co-view data and content data of the anchor item. In one or more cases, the program instructions comprise determining one or more items that complement the one or more similar items, based on co-purchase data of the one or more similar items. In one or more cases, the program instructions comprise generating recommended complementary item data for the anchor item. In one or more cases, the recommended complementary item data is generated based on the co-purchase data and at least one of the co-view data and the content data.

### BRIEF DESCRIPTION OF THE DRAWINGS

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1 is a functional block diagram of a data processing environment, in accordance with one or more embodiments.

FIG. 2 is a functional block diagram illustrating components of the data processing environment of FIG. 1, in accordance with one or more embodiments.

FIG. 3 is a flowchart illustrating a process of providing enhanced complementary recommendations, in accordance with one or more embodiments.

FIG. 4A illustrates items similar to an example anchor item and their example complementary items.

FIG. 4B is an example ranking of the example complementary items of FIG. 4A.

FIG. 4C is an example view of a web page displaying example complementary item recommendations.

FIG. 5 depicts a block diagram of components of a computing device capable of performing the processes described herein, in accordance with one or more embodiments.

### DETAILED DESCRIPTION

The following discussion omits or only briefly describes conventional features of the data processing environment, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Embodiments of the disclosure relate generally to providing complementary recommendations, and more particularly, to providing enhanced complementary recommendations using transfer learning. Embodiments that provide enhanced complementary recommendations are described below with reference to the figures.

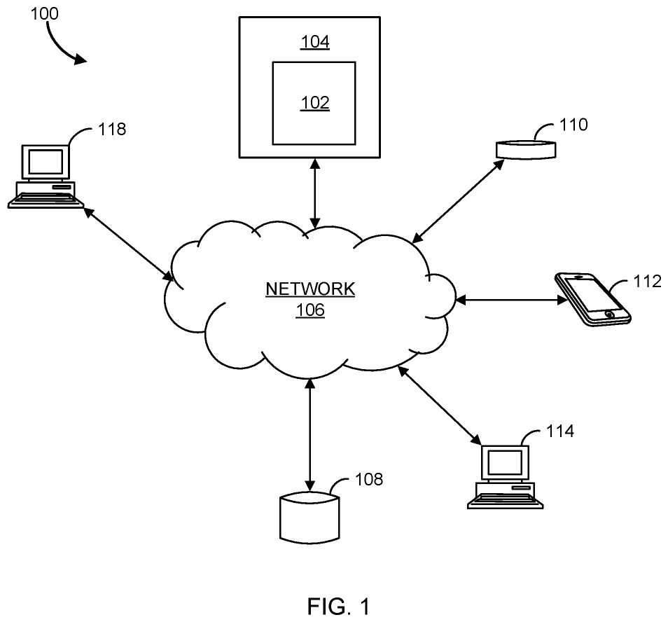

FIG. 1 is a functional block diagram of a data processing environment 100. FIG. 1 provides only an illustration of one implementation and does not imply any limitations with regard to the environments in which different embodiments may be implemented. Many modifications of the depicted environment may be made by those skilled in the art without departing from the scope of the claims. In one or more cases, the data processing environment 100 includes a server 104, which operates a complementary recommendation system 102 (hereinafter “system 102”), a data storage repository 108, and one or more computing devices, such as computing device 118 and customer devices 110, 112, and 114 coupled over a network 106. The server 104, system 102, data storage repository 108, and devices 110, 112, 114, and 118 can each be any suitable computing device that includes any hardware or hardware and software combination for processing and handling information, and transmitting and receiving data among the server 104, system 102, data storage repository 108, and devices 110, 112, 114, and 118.

The server 104, system 102, data storage repository 108, and devices 110, 112, 114, and 118 can each include one or more processors, one or more field-programmable gate arrays (FPGAs), one or more application-specific integrated circuits (ASICs), one or more state machines, digital circuitry, or any other suitable circuitry.

The network 106 interconnects the server 104, the data storage repository 108, and one or more of the devices 110, 112, and 114. In general, the network 106 can be any combination of connections and protocols capable of supporting communication between the server 104, the data storage repository 108, one or more of the computing devices 110, 112, 114, and 118, and the system 102. For example, the network 106 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. In one or more cases, the network 106 may include wire cables, wireless communication links, fiber optic cables, routers, switches, firewalls, or any combination that can include wired, wireless, or fiber optic connections known by those skilled in the art.

In one or more cases, the server 104 hosts the system 102. In some cases, the server 104 may be a web server, a blade server, a mobile computing device, a laptop computer, a tablet computer, a netbook computer, a personal computer (PC), a desktop computer, or any programmable electronic device or computing system capable of receiving and sending data, via the network 106, and performing computer-readable program instructions. For example, for the cases in which the server 104 is a web server, the server 104 may host one or more pages of a website. Each of the computing devices 110, 112, 114, and 118 may be operable to view, access, and interact with the web pages hosted by the server 104. In one or more examples, the server 104 hosts a website, such as an e-commerce website, for a retailer to sell items and for a customer to purchase an item via one or more web pages. For example, a user of a computing device, such as the computing device 110, 112, or 114, may access a web page, add one or more items to an online shopping cart, and perform an online checkout of the shopping cart to purchase the items. In another example, a user of the computing device 118 may access one or more aspects of the system 102, for instance, to upload a cold start item to the e-commerce website and to generate items that complement the cold start item. In other cases, the server 104 can be a data center, which includes a collection of networks and servers, such as virtual servers and applications deployed on virtual servers, providing an external party access to the system 102. In some other cases, the server 104 represents a computing system utilizing clustered computers and components (e.g., database server computer, application server computers, etc.) that act as a single pool of seamless resources, such as in a cloud computing environment, when accessed within data processing environment 100.

In one or more cases, the data storage repository 108 may store data including, but not limited to, items listed for sale on an e-commerce website, content data, co-purchase data, co-view data, and a ranking algorithm. The data storage repository 108 may be one of, a web server, a mobile computing device, a laptop computer, a tablet computer, a netbook computer, a personal computer (PC), a desktop computer, or any programmable electronic device or computing system capable of receiving, storing, sending data, and performing computer readable program instructions capable of communicating with the server 104, computing devices 110, 112, 114, and 118, via network 106. In one or more cases, the data storage repository 108 may represent virtual instances operating on a computing system utilizing clustered computers and components (e.g., database server computer, application server computers, etc.) that act as a single pool of seamless resources when accessed within data processing environment 100. In one or more cases, the data storage repository 108 may be a remote storage device. In one or more other cases, the data storage repository 108 may be a local storage device on the server 104. For example, the data storage repository 108 may be, but not limited to, a hard drive, non-volatile memory, or a USB stick.

In one or more cases, devices 110, 112, 114, and 118 are clients to the server 104. The devices 110, 112, 114, and 118 may be, for example, a desktop computer, a laptop computer, a tablet computer, a personal digital assistant (PDA), a smart phone, a thin client, a voice assistant device, a digital assistant, or any other electronic device or computing system capable of communicating with server 104 through network 102. For example, device 118 may be a desktop computer capable of connecting to the network 106 to upload one or more cold start items to the system 102, and device 112 may be a mobile device capable of connecting to the network 106 and receiving an input to add an item to a customer's cart on an e-commerce website. In one or more cases, one or more of the devices 110, 112, 114, and 118 may be any suitable type of mobile device capable of running mobile applications, including smart phones, tablets, slate, or any type of device that runs a mobile operating system.

In one or more cases, one or more of the devices 110, 112, 114, and 118 includes a user interface for providing an end user with the capability to interact with the system 102. For example, an end user of the computing device 118 may access the system 102 through the user interface to upload an item to sell on an e-commerce website. A user interface refers to the information (such as graphic, text, and sound) a program presents to a user and the control sequences the user employs to control the program. The user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation. For example, the GUI may allow users to view, access, and interact with a website hosted on the server 104.

In one or more cases, one or more of the devices 110, 112, 114, and 118 can be any wearable electronic device, including wearable electronic devices affixed to, for example but not limited to, eyeglasses and sunglasses, helmets, wristwatches, clothing, and the like, and capable of sending, receiving, and processing data. For example, the device 110 may be a wearable electronic device, such as a wristwatch, capable of accessing an e-commerce website and receiving an input to add an item to a customer's cart on the e-commerce website.

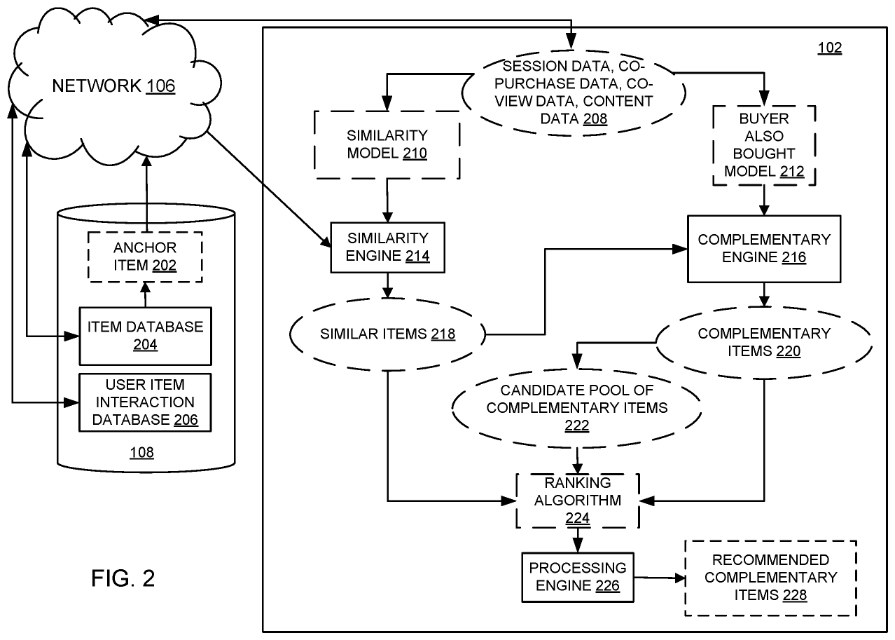

FIG. 2 is a functional block diagram illustrating components of the data processing environment 100 of FIG. 1.

In one or more cases, the data storage repository 108 includes one or more databases for storing information. For example, the data storage repository 108 may include an item database 204 and a user item interaction database 206. The item database 204 may store items listed for sale on the e-commerce website and content data that corresponds to an item. The item database 204 may also store offline models, such as a similarity model 210 and a buyer also bought model 212. For a given anchor item, the item database 204 may store recommended complementary items 228 and the score the items 228 based on relevance to an anchor item 202. Content data may include metadata of items that have similar features (e.g., images, text, brands, categories, cross-sites, descriptions of items, and the like). The data storage repository 108 may also include a user item interaction database 206 configured to store user interactions between items on the e-commerce website. That is, the user item interaction database 206 may store at least one of session data, co-purchase data, co-view data, view-buy data. View-buy data may be data that corresponds to a number of times customers viewed one item and purchased another item within the same session. Co-purchase data may be data that corresponds to similar items (e.g., a television and a television mount) that customers purchased. For example, co-purchase data may include a user item interaction in which a customer purchases item A and item B, which complements item A (in one example, item A is a television, and item B is a television mount; and in another example, item A is a television, and item B is a protection plan for the television). Co-view data may be data that corresponds to sets of similar items that customers viewed within a session. Co-view data may include a user item interaction in which a user views item A on the e-commerce web page and views item B on the e-commerce web page within a session. For example, if a customer decides to purchase a phone case, e.g., item A, the customer may view several phone cases, e.g., item B, within a session before purchasing a phone case. Session data may be, for example but not limited to, a number of times that customers viewed an item within a time period, a number of times that customers added the item to the online shopping cart within a time period, and/or a number of times that customers viewed recommended items displayed on the website. The session data may include the session in which a customer is actively engaged with the website, e.g., from a time-period a user lands on the website until a time period in which the user exits the website. In one or more cases, the system 102 may track user item interactions in a session by tracking website cookies of the customer. The system 102 may determine that a session ended when the website cookies expire. The website cookies may expire when the customer exits the website, or when the customer is inactive on the website for a certain period of time. It is noted that FIG. 2 illustrates the item database 204 and the user item interaction database 206 as being separate databases localized on the data storage repository 108; however, it should be understood that the item database 204 and the user item interaction database 206 may be positioned on the same data storage repository or on different data storage repositories. Moreover, the data storage repository 108 may store the items and user item interactions in one database or multiple databases.

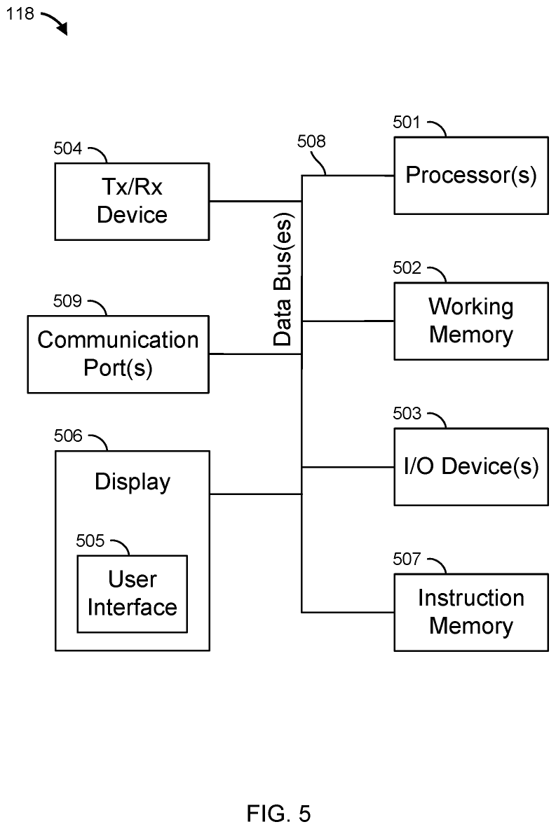

In one or more cases, the system 102 includes a similarity engine 214, a complementary engine 216, and a processing engine 226. In one or more examples, one or more of the similarity engine 214, the complementary engine 216, and the processing engine 226 may be implemented in hardware. In one or more examples, one or more of the similarity engine 214, the complementary engine 216, and the processing engine 226 may be implemented as an executable program maintained in a tangible, non-transitory memory, such as instruction memory 507 of FIG. 5, which may be executed by one or processors, such as processor 501 of FIG. 1.

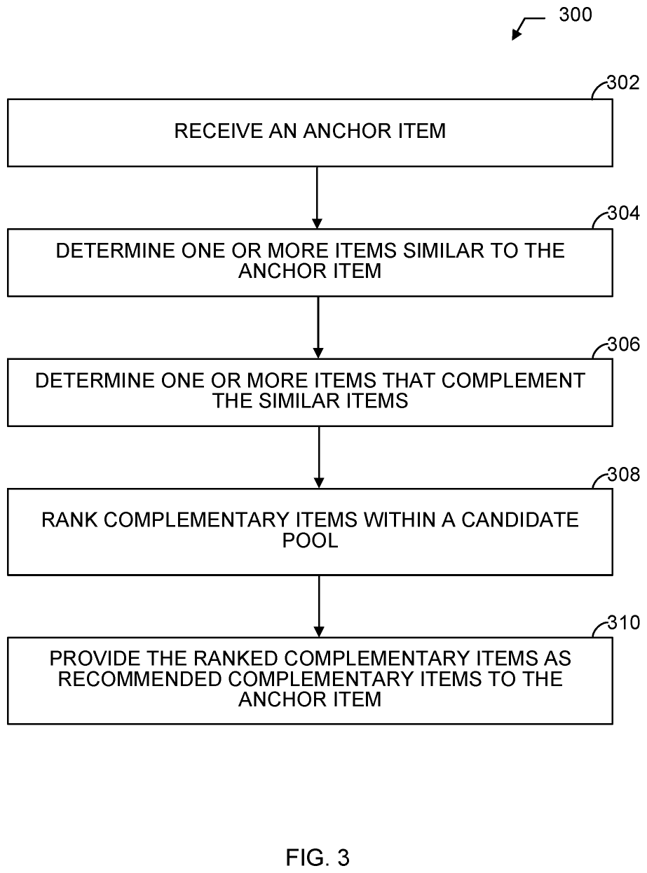

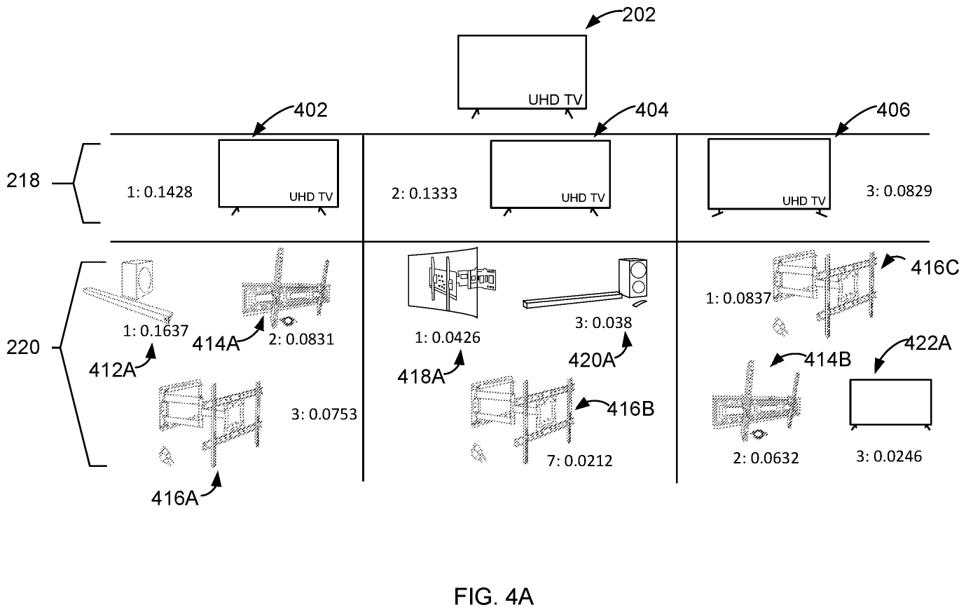

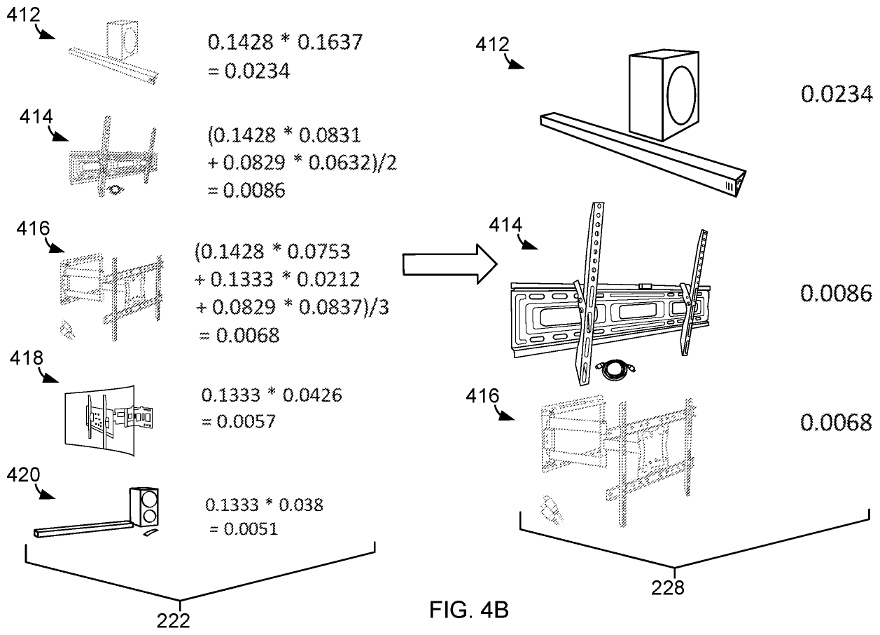

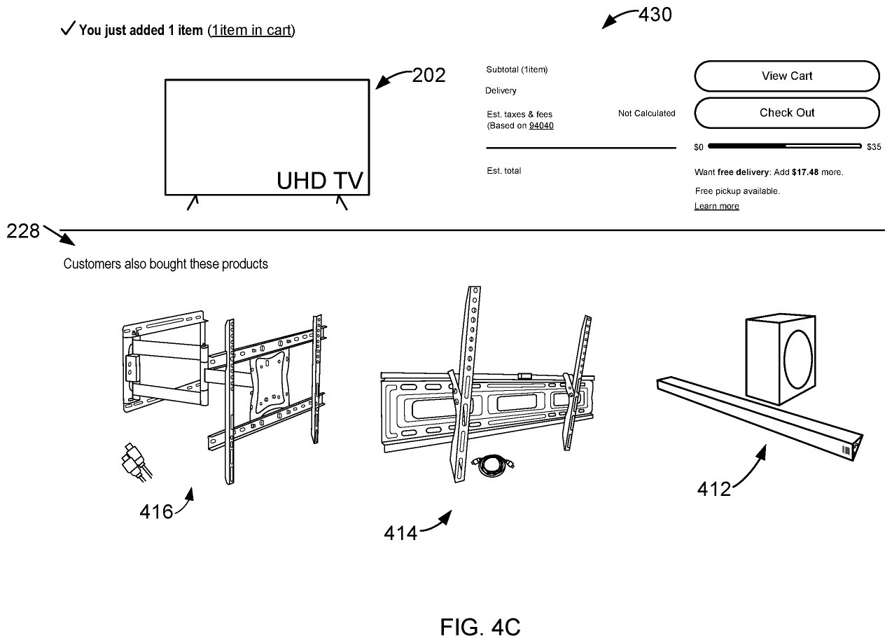

FIG. 3 is a flowchart illustrating a process 300 of providing enhanced complementary recommendations. FIG. 4A illustrates items similar to an example anchor item and their example complementary items. FIG. 4B is an example ranking of the example complementary items of FIG. 4A. FIG. 4C is an example view of a webpage displaying example recommended complementary items.

It is noted that, while the examples discussed herein are directed to providing complementary recommendations for televisions, the embodiments discussed herein may be used to provide complementary recommendations for any type of product offered for sale, and are not limited to providing complementary recommendations for televisions. Moreover, the embodiments discussed herein may be directed to providing complementary recommendations for any type of product within any category of the e-commerce website.

An anchor item is received (302), preferably by the system 102. In one or more cases, the system 102 receives the anchor item 202 from the data storage repository 108. For example, the data storage repository 108 may retrieve the anchor item 202 from the item database 204, and transmit the anchor item 202 to the similarity engine 214 of the system 102, via the network 106. The anchor item 202 may be, for example, a cold start item. A cold start item may be an item that was not purchased (i.e., having no historical transaction data of being purchased), not purchased with one or more complimentary items (i.e., having no co-purchase data), or that does not have enough historical transaction data and/or co-purchase data for the system 102 to provide a customer with recommended complementary items to the anchor item. A cold start item that does not have enough historical transaction data and/or co-purchase data may be, for example, an item that does not have many customer views. The item may not have many views because the item was recently introduced on the website, and/or the item does not surface in relevant context to a customer's search. In one or more cases, the system 102 may receive the anchor item 202 in response to a user adding the anchor item 202 to an online shopping cart. Having received the anchor item 202, the system 102 may determine whether the anchor item 202 is a cold start item. In one or more other cases, the system 102 may receive the anchor item 202 in response to the anchor item 202 being uploaded to the item database 204, such as when an item is introduced on the website. In one or more other cases, the system 102 may receive the anchor item 202 in response to an operator of the system 102 providing the anchor item 202. For example, in the alternative to a user adding the anchor item 202 to the online shopping cart, an operator of the system 102 may provide cold start items to the system 202 in order to generate recommended complementary items 228 for the respective cold start items.

In response to determining that the anchor item is a cold start item, the system 102 retrieves at least one of session data, co-purchase data, co-view data, and content data 208 from the data storage repository 108. The system 102 provides at least one of the session data, co-view data, and content data to the similarity engine 214. The system 102 provides the session data and co-purchase data to the complementary engine 216.

One or more items similar to the anchor item 202 are determined (304), preferably by the similarity engine 214. In one or more cases, the similarity engine 214 determines the one or more similar items 218 by executing a similarity model 210 using either the session data and the co-view data, the session data and the content data, the session data and the view-buy data, or any combination of the aforementioned, such as the session data, the co-view data, and the content data. The similarity model 210 may be based on, for example, one or more machine learning algorithms, such as Logistics Regression, Random Forest, Gradient Boosting Machines, or any other suitable learning algorithms. The similarity model 210 may be trained, for example, on either the session data and the co-view data, the session data and the content data, or the session data, the co-view data, and the content data.

For the cases in which the anchor item 202 has corresponding co-view data, the similarity engine 214 applies the similarity model 210 to the co-view data and the session data to determine the items 218 that are similar to the anchor item 202. The similarity model 210 may generate a similarity score for each of the similar items 218. For example, the anchor item 202 may be a 65-inch Class 4K Ultra HP (2160P) HDR Smart LED TV (2019 Model). The similarity engine 214 may determine that the anchor item 202 has co-view data for the similar items 218 (e.g., item 402, item 404, and item 406) within a session, for example, within the previous seven days. Item 402 may be, for example, a 65-inch Class 4K Ultra HP (2160P) HDR Smart TV (2019 Model), in which the similarity model 210 generates a score of 0.1428. Item 404 may be, for example, a 65-inch Class 4K Ultra HP (2160P) Curved HDR Smart LED TV (2019 Model), in which the similarity model 210 generates a score of 0.1333. Item 406 may be, for example, a 65-inch Class 4K Ultra HP (2160P) LED Smart TV with HDR, in which the similarity model 210 generates a score of 0.0829. For the cases in which the anchor item 202 does not have corresponding co-view data, the similarity engine 214 may determine the similar items 218 based on the content data and the session data. For example, the content data may include data that corresponds to a brand of the item, one or more images of the item, a description and/or summary of the item, a title of the item, product hierarchy of the item, and the like. The similarity engine 214 may apply the similarity model 210 to the content data and the session data to generate the similarity score for the similar items 218. In one or more other cases, the similarity engine 214 may apply the similarity model 210 to the co-view data, content data, and the session data to generate the similarity score for the similar items 218. In one or more cases, to generate a similarity score for the similar items 218, the similarity engine 214 may leverage the session data to determine an amount of weight to place on different content features, such as brand, one or more images, description, summary, title, or the like.

One or more items 220 that complement the similar items 218 are determined (306), preferably by the complementary engine 216. In one or more cases, the complementary engine 216 determines the one or more complementary items 220 by receiving the similar items 218 from the similarity engine 214 and retrieving the co-purchase data (i.e., the complementary items 220) for the similar items 218. For example, the complementary engine 216 may receive similar items 218 (e.g., items 402, 404, and 406) from the similarity engine 214, and based on the co-purchase data, the complementary engine 216 may determine that the complementary items for item 402 are items 412A, 414A, and 416A; the complementary items for item 404 are items 418A, 420A, and 416B; and the complementary items for item 406 are items 416C, 414B, and 422A. The complementary engine 216 may apply a buyer also bought (BAB) model 212 to the complementary items 220 to generate a complementary score (i.e., a cross-sell score) for each of the complementary items 220. For example, the complementary engine 216 may apply the BAB model 212 to a set of speakers 412A generating a complementary score of 0.1637, a first wall mount 414A generating a complementary score of 0.0831, and a second wall mount 416A generating a complementary score of 0.0753; a third wall mount 418A generating a complementary score of 0.0426, a second set of speakers 416B generating a complementary score of 0.0212, and the second wall mount 420A generating a complementary score of 0.038; and the second wall mount 416C generating a complementary score of 0.0837, the first wall mount 414B generating a complementary score of 0.0632, and a television 422A generating a complementary score of 0.0246. It is noted that the complementary items may be the same items, such as complimentary items 416A, 416B, and 416C; however, based on the respective similar item 218, the BAB model 212 may generate a different complementary score for each of complementary items 416A, 416B, and 416C. In one or more cases, the complementary engine 216 may simultaneously generate the complementary items 220 and their corresponding complementary scores. The BAB model 212 may be based on, for example, one or more machine learning algorithms, such as Logistics Regression, Random Forest, Gradient Boosting Machines, or any other suitable learning algorithms. The similarity model 210 may be trained, for example, on co-purchase data. In one or more other cases, the complementary scores for the complementary items 220 may be predetermined, such that when the complementary engine 216 receives the co-purchase data for the similar items 218, the complementary engine 216 also receives the complementary scores. The similar items 218, the complementary items 220, and their corresponding similarity scores and complementary scores for a given anchor item may be stored as a static reserve within the item database 204. When the system 102 retrieves a complementary item for a cold start item, the system 102 may also retrieve the predetermined similar items 218, the complementary items 220, and their corresponding similarity scores and complementary scores from the static reserve.

In one or more cases, the complementary engine 216 may generate a candidate pool of complementary items 222 by grouping together the same complementary items. For example, the complementary engine 216 may group the set of speakers 412A into candidate pool group 412; the first wall mounts 414A and 414B into candidate pool group 414; the second wall mounts 416A, 416B, and 416C into candidate pool group 416; the third wall mount 418A into candidate pool group 418; and the second set of speakers 420A into candidate pool group 420.

The complementary items 222 within the candidate pool may be ranked (308), preferably by the processing engine 226. In one or more cases, the processing engine 226 may apply a ranking algorithm 224 to candidate pools 222 to determine the relevance of a complementary item 220 to the anchor item 202. To rank the complementary items within the candidate pool 222, the processing engine 226 may calculate a relevance score for each candidate pool group. That is, the processing engine 226 may determine, for the cases in which a complementary item is repeated within a complementary pool group, an average score of the complimentary items within a candidate pool group, and determine, for the cases in which there is only one complementary item within the complementary pool group, a score by multiplying the complementary score for the complementary item and the similarity score for the corresponding similarity item 218. For example, the processing engine 226 may calculate a relevance score by calculating the summation of the score of a similar item 218 multiplied by the score of a corresponding complementary item 220 for each complementary item 220 within a candidate pool group. For example, to generate a relevance score for candidate pool group 416, the processing engine 226 calculates the summation of the score for similar item 402 (e.g., 0.1428) multiplied by the score for complementary item 416A (e.g., 0.0753), the score for similar item 404 (e.g., 0.1333) multiplied by the score for complementary item 416B (e.g., 0.0212), and the score for similar item 406 (e.g., 0.0829) multiplied by the score for complementary item 416C (e.g., 0.0837), and determines the average of these scores to obtain a relevance score of 0.0068. Similarly, the processing engine 226 may calculate a relevance score of 0.0086 for candidate pool 414 and a relevance score of 0.0234 for candidate pool 412, as shown in FIG. 4B.

Having determined the relevance scores for the complementary items within the candidate pool, the processing engine 226 may rank the complementary items based on their relevance to the anchor item 202. In one or more cases, the processing engine 226 may rank the complementary items in descending order of relevance to the anchor item 202. For example, the processing engine 226 may rank the complimentary item associated with candidate pool group 414 as being more relevant than the complimentary item associated with candidate pool group 412, and the complimentary item associated with candidate pool group 416 as being more relevant than the complimentary items associated with candidate pool groups 414 and 412.

The ranked complimentary items 228 are provided, preferably by the processing engine 226, as recommended complementary items 428 to the anchor item 202 (310). In one or more cases, having ranked the complimentary items 228, the processing engine 226 provides the recommended complementary items 228 to an end user, such as a customer. The processing engine 226 may provide the recommended complementary items 228 by transmitting the recommended complementary items to a client device, for example, client device 112, which displays the anchor item 202 along with the recommended complementary items 428 on, for example, the add-to-cart page 430 of the e-commerce website, as shown in FIG. 4C.

In one or more cases, the system 102 may apply a top-up model to the ranked complementary items 228 to output ranked complementary items 228 based on a price range. For example, the system 102 may determine that the total value of items within the online shopping cart is $27.00, and in order for the customer to receive free shipping, the customer would need to buy another $8.00 worth of items. The top-up model may filter the ranked complementary items 228 to complementary items that have an individual value of $8.00 or more, and provide these complementary items as recommended complementary items.

In one or more examples, compared to the recommended complementary items provided by cross-selling models, the enhanced recommended complementary items provided by the process 300 may create about a 0.75% lift in user interaction on an add-to-cart page. Additionally, in one or more examples, compared to conventional cross-selling models, the enhanced recommended complementary items increase item page views from customers by about 0.38%. Moreover, by utilizing co-view data and/or content data to generate enhanced complementary recommendations, the process 300 may recommend a wider variety of complementary items to a customer than conventional cross-selling models. For instance, the process 300 may improve coverage of complementary items to about 78% compared to the 50% coverage that conventional cross-selling models may provide.

FIG. 5 depicts a block diagram of components of a computing device capable of performing the processes described herein. In particular, FIG. 5 illustrates an example computing device, such as computing device 118, capable of interacting with the system 102 of FIG. 1.

Computing device 118 can include one or more processors 501, working memory 502, one or more input/output devices 503, instruction memory 507, a transceiver 504, one or more communication ports 509, and a display 506, all operatively coupled to one or more data buses 508. Data buses 508 allow for communication among the various devices. Data buses 508 can include wired, or wireless, communication channels.

Processors 501 can include one or more distinct processors, each having one or more cores. Each of the distinct processors can have the same or different structure. Processors 501 can include one or more central processing units (CPUs), one or more graphics processing units (GPUs), application specific integrated circuits (ASICs), digital signal processors (DSPs), and the like.

Processors 501 can be configured to perform a certain function or operation by executing code, stored on instruction memory 507, embodying the function or operation. For example, processors 501 can be configured to perform one or more of any function, method, or operation disclosed herein.

Instruction memory 507 can store instructions that can be accessed (e.g., read) and executed by processors 501. For example, instruction memory 507 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 501 can store data to, and read data from, working memory 502. For example, processors 501 can store a working set of instructions to working memory 502, such as instructions loaded from instruction memory 507. Processors 501 can also use working memory 502 to store dynamic data created during the operation of the system 102. Working memory 502 can be a random access memory (RAM) such as a static random access memory (SRAM) or dynamic random access memory (DRAM), or any other suitable memory.

Input-output devices 503 can include any suitable device that allows for data input or output. For example, input-output devices 503 can include one or more of a keyboard, a touchpad, a mouse, a stylus, a touchscreen, a physical button, a speaker, a microphone, or any other suitable input or output device.

Communication port(s) 509 can include, for example, a serial port such as a universal asynchronous receiver/transmitter (UART) connection, a Universal Serial Bus (USB) connection, or any other suitable communication port or connection. In some examples, communication port(s) 509 allows for the programming of executable instructions in instruction memory 509. In some examples, communication port(s) 509 allow for the transfer (e.g., uploading or downloading) of data, such as transaction data.

Display 506 can display user interface 505. User interfaces 505 can enable user interaction with, for example, computing device 112 or 118. For example, user interface 505 can be a user interface for an application of a retailer that allows a customer to purchase one or more items from the retailer. In some examples, a user can interact with user interface 505 by engaging input-output devices 503. In some examples, display 506 can be a touchscreen, in which the touchscreen displays the user interface 505.

Transceiver 504 allows for communication with a network, such as the communication network 118 of FIG. 1. For example, if network 106 of FIG. 1 is a cellular network, transceiver 504 is configured to allow communications with the cellular network. In some examples, transceiver 504 is selected based on the type of network 106 system 102 will be operating in. Processor(s) 501 is operable to receive data from, or send data to, a network, such as network 106 of FIG. 1, via transceiver 504.

Although the embodiments discussed herein are described with reference to the figures, it will be appreciated that many other ways of performing the acts associated with the embodiments can be used. For example, the order of some operations may be changed, and some of the operations described may be optional.

In addition, the embodiments described herein can be at least partially implemented in the form of computer-implemented processes and apparatus. The disclosed embodiments may also be at least partially implemented in the form of tangible, non-transitory machine-readable storage media encoded with computer program code. For example, the processes described herein can be implemented in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the embodiments. The embodiments may also be at least partially implemented in the form of a computer into which computer program code is loaded or executed, such that, the computer becomes a special purpose computer for practicing the embodiments. When implemented on a general-purpose processor, the computer program code segments configure the processor to create specific logic circuits. The embodiments may alternatively be at least partially implemented in application specific integrated circuits for performing the embodiments.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A system comprising:
a computing device configured to:
receive an anchor item;
determine one or more items similar to the anchor item, based on at least one of co-view data and content data of the anchor item;
determine one or more items that complement the one or more similar items, based on co-purchase data of the one or more similar items; and
generate recommended complementary item data for the anchor item,
wherein the recommended complementary item data is generated based on the co-purchase data and at least one of the co-view data and the content data.

2. The system of claim 1, wherein the anchor item is offered for sale on an e-commerce website.

3. The system of claim 1, wherein the anchor item is received in response to the anchor item being placed in an online shopping cart.

4. The system of claim 1, wherein the anchor item is a cold start item.

5. The system of claim 1, wherein the co-view data corresponds to the one or more similar items viewed with the anchor item by one or more users within a session.

6. The system of claim 1, wherein the content data corresponds to features of the one or more similar items that are similar to features of the anchor item.

7. The system of claim 1, wherein co-purchase data corresponds to one or more items purchased with the one or more similar items within a session.

8. The system of claim 1, wherein:
determining the one or more similar items comprises applying a similarity model to at least one of the co-view data and the content data to generate a similarity score for each of the one or more similar items; and
determining the one or more complementary items comprises applying a buyer also bought model to the co-purchase data to generate a complementary score for each of the one or more complementary items.

9. The system of claim 8, wherein generating the recommended complementary item data comprises ranking the one or more complementary items in order of relevance.

10. The system of claim 9, wherein the ranking of the one or more complementary items is based on the similarity score and the complementary score for each of the one or more complementary items.

11. The system of claim 9, wherein the computing device is further configured to provide the ranked one or more complementary items as recommended complementary items to the anchor item.

12. A method comprising:
receiving an anchor item;
determining one or more items similar to the anchor item, based on at least one of co-view data and content data of the anchor item;
determining one or more items that complement the one or more similar items, based on co-purchase data of the one or more similar items; and
generating recommended complementary item data for the anchor item,
wherein the recommended complementary item data is generated based on the co-purchase data and at least one of the co-view data and the content data.

13. The method of claim 1, wherein receiving the anchor item comprises receiving the anchor item in response to the anchor item being placed in an online shopping cart, and wherein the anchor item is a cold start item.

14. The method of claim 1, wherein the co-view data corresponds to the one or more similar items viewed with the anchor item by one or more users within a session,
wherein the content data corresponds to features of the one or more similar items that are similar to features of the anchor item, and
wherein co-purchase data corresponds to one or more items purchased with the one or more similar items within a session.

15. The method of claim 1, further comprising:
determining the one or more similar items comprises applying a similarity model to at least one of the co-view data and the content data to generate a similarity score for each of the one or more similar items; and
determining the one or more complementary items comprises applying a buyer also bought model to the co-purchase data to generate a complementary score for each of the one or more complementary items.

16. The method of claim 1, wherein generating the recommended complementary item data comprises ranking the one or more complementary items in order of relevance based on the similarity score and the complementary score for each of the one or more complementary items, and
wherein the method further comprises providing the ranked one or more complementary items as recommended complementary items to the anchor item.

17. A computer program product comprising:
a non-transitory computer readable medium having program instructions stored thereon, the program instructions executable by one or more processors, the program instructions comprising:
receiving an anchor item;
determining one or more items similar to the anchor item, based on at least one of co-view data and content data of the anchor item;
determining one or more items that complement the one or more similar items, based on co-purchase data of the one or more similar items; and
generating recommended complementary item data for the anchor item,
wherein the recommended complementary item data is generated based on the co-purchase data and at least one of the co-view data and the content data.

18. The computer program product of claim 17, wherein the anchor item is received in response to the anchor item being placed in an online shopping cart, and wherein the anchor item is a cold start item.

19. The computer program product of claim 17, wherein the program instructions further comprise:
determining the one or more similar items comprises applying a similarity model to at least one of the co-view data and the content data to generate a similarity score for each of the one or more similar items; and
determining the one or more complementary items comprises applying a buyer also bought model to the co-purchase data to generate a complementary score for each of the one or more complementary items.

20. The computer program product of claim 17, wherein generating the recommended complementary item data comprises ranking the one or more complementary items in order of relevance based on the similarity score and the complementary score for each of the one or more complementary items, and
wherein the program instructions further comprise providing the ranked one or more complementary items as recommended complementary items to the anchor item.
